(19) United States
(12) Patent Application Publication
(10) Pub. No.: US 2026/0222023 A1
(43) Pub. Date: Jul. 30, 2026

(54) TIME SYNCHRONIZATION STATUS CODEBOOKS

(71) Applicant: Telefonaktiebolaget LM Ericsson (publ), Stockholm (SE)

(72) Inventors: Shabnam Sultana, MONTREAL, Québec (CA); Paul Schliwa-Bertling, LJUNGSBRO (SE); Mattias Bergström, Singapore (SG); Nianshan Shi, Järfälla (SE); Aleksejs Udalcovs, Stockholm (SE); Marilet De Andrade Jardim, KISTA (SE)

(21) Appl. No.: 19/144,621

(22) PCT Filed: Jan. 9, 2024
(86) PCT No.: PCT/EP2024/050329

§ 371 Date: Jun. 30, 2025

Related U.S. Application Data
(60) Provisional application No. 63/437,871, filed on Jan. 9, 2023.

(51) Int. Cl. H04B 7/0456; H04W 36/00; H04W 56/00; H04W 76/27

(52) U.S. Cl. CPC H04B 7/0456; H04W 36/0072; H04W 56/001; H04W 76/27

(57) ABSTRACT

Systems and methods related to time synchronization status codebooks in a wireless network are disclosed. In one embodiment, a method performed by a User Equipment (UE) comprises receiving, from a network node of a wireless network, one or more time status information instance codebooks each comprising a set of possible time status information instances associated to respective time status information instance identifiers. The method further comprises storing the one or more time status information instance codebooks. As a result, the number of UEs in idle or inactive state that need to move to connected state at the same time after receiving an indication about changes in time synchronization status can be reduced. Corresponding embodiments of a UE are also disclosed. Embodiments of a network node and a method of operation thereof are also disclosed.

### RELATED APPLICATIONS

This application claims the benefit of provisional patent application Ser. No. 63/437,871, filed Jan. 9, 2023, the disclosure of which is hereby incorporated herein by reference in its entirety.

### TECHNICAL FIELD

The present disclosure relates to a wireless network (e.g., a cellular communications system) and, more specifically, informing various nodes of a time synchronization status of the wireless network.

### BACKGROUND

The 3^{rd} Generation Partnership Project (3GPP) is conducting a study introducing support for Timing Resiliency. The study is justified by the following passages from S2-2210400 which are relevant to the present disclosure and quoted below:
1) SA1 is specifying requirements for 5G [(5^{th} Generation)] System to remain time resilient if there is GNSS [(Global Navigation Satellite System)] failure and for 5G System to act as a backup and offer wireless and indoor-capable time synchronization service for other applications (e.g. financial, power grid systems).

In this study, which is documented in the following text from 3GPP Technical Report (TR) 23.700-25v2.0.0, so called Key Issue #1 needs to be addressed:
The objective of this Key Issue is to study the monitoring and reporting for timing synchronization status in 5GS [(5G System)].
For this Key Issue the following areas should be studied:
   Study how RAN [(Radio Access Network)] and 5GC [(5G Core)] learn about 5GS network timing synchronization status to be able to inform UEs [(User Equipments)] (e.g. application running in the UE), devices attached to the UE (i.e. that receive time information from 5GS) and Afs [(Application Functions)].
      Study how to report 5GS network timing synchronization status (such as divergence from UTC [(Coordinated Universal Time)] and 5GS network timing source degradation) to UEs (e.g. application running in the UE), devices attached to the UE (i.e. that receive time information from 5GS) and 3rd party applications (AFs).
      Study if additional information needs to be provided to UEs and AFs to inform about 5GS network timing synchronization status.

### SUMMARY

Systems and methods related to time synchronization status codebooks in a wireless network are disclosed. In one embodiment, a method performed by a User Equipment (UE) comprises receiving, from a network node of a wireless network, one or more time status information instance codebooks each comprising a set of possible time status information instances associated to respective time status information instance identifiers. The method further comprises storing the one or more time status information instance codebooks. As a result, the number of UEs in idle or inactive state that need to move to connected state at the same time after receiving an indication about changes in time synchronization status can be reduced.

In one embodiment, the method further comprises receiving a time status information instance identifier from a Radio Access Network (RAN) node.

In one embodiment, the one or more time status information instance codebooks consists of a single time status information instance codebook, and the method further comprises determining that a time status information instance in the single time status information instance codebook that is associated to the received time status information instance identifier is time status information applicable to the UE.

In one embodiment, the one or more time status information instance codebooks comprise two or more time status information instance codebooks, and the method further comprises selecting a particular time status information instance codebook from the two or more time status information instance codebooks and determining that a time status information instance in the particular time status information instance codebook that is associated to the received time status information instance identifier is time status information applicable to the UE. In one embodiment, the method further comprises receiving an indication of a particular time status information instance codebook from the two or more time status information instance codebooks to be used by the UE, wherein selecting the particular time status information instance codebook comprises selecting the particular time status information instance codebook from the two or more time status information instance codebooks based on the received indication. In another embodiment, selecting the particular time status information instance codebook comprises selecting the particular time status information instance codebook from the two or more time status information instance codebooks based on one or more criteria.

In one embodiment, the method further comprises performing one or more actions based on the time status information applicable to the UE as determined based on the received time status information instance identifier.

In one embodiment, the method further comprises determining that the received time status information instance identifier does not correspond to any time status information instance in the one or more time status information instance codebooks and, responsive thereto, transitioning to a connected state and receiving a time status report from a network node while in the connected state.

In one embodiment, the network node is a network node in a cellular communications system, and each time status information instance in each of the one or more time status information instance codebooks comprises information about a time synchronization status of the cellular communications system.

In one embodiment, each time status information instance in the set of possible time status information instances comprises any one or more of the following: information about a divergence of a timing of the wireless network from Coordinated Universal Time (UTC) and information about a degradation of a timing source of the wireless network.

In one embodiment, at least one time status information instance in the set of possible time status information instances comprises one or more clock quality metrics that reflect a current timing synchronization status of the wireless network. In one embodiment, the one or more clock quality metrics comprise any one or more of the following: timing synchronization state, timing synchronization source type, clock quality descriptor, clock accuracy, traceability to UTC, and frequency stability.

In one embodiment, at least one time status information instance in the set of possible time status information instances comprises either an acceptable indication or a not acceptable indication.

In one embodiment, the method further comprises determining that a new time status information instance codebook is needed and, responsive to determining that a new time status information instance codebook is needed, obtaining one or more new time status information instance codebooks from a network node.

In one embodiment, the method further comprises receiving one or more new status information instance codebooks from a network node.

In one embodiment, the network node is a core network node.

In one embodiment, the network node is a RAN node.

Corresponding embodiments of a UE are also disclosed. In one embodiment, a UE is adapted to receive, from a network node of a wireless network, one or more time status information instance codebooks each comprising a set of possible time status information instances associated to respective time status information instance identifiers and store the one or more time status information instance codebooks.

In one embodiment, the UE comprises a communication interface comprising a transmitter and a receiver, and processing circuitry associated with the communication interface. The processing circuitry is configured to cause the UE to receive the one or more time status information instance codebooks from the network node and store the one or more time status information instance codebooks.

Embodiments of a method performed by a network node are also disclosed. In one embodiment, a method performed by a network node of a wireless network comprises providing, to a UE, one or more time status information instance codebooks each comprising a set of possible time status information instances associated to respective time status information instance identifiers.

In one embodiment, the network node is a RAN node. In one embodiment, the method further comprises transmitting a time status information instance identifier to the UE, the time status information instance identifier being associated to a time status information instance in one of the one or more time status information instance codebooks. In one embodiment, the one or more time status information instance codebooks consists of a single time status information instance codebook, and the time status information instance identifier is associated to a time status information instance in the single time status information instance codebook. In another embodiment, the one or more time status information instance codebooks comprise two or more time status information instance codebooks, and the method further comprises transmitting, to the UE, an indication of a particular time status information instance codebook from the two or more time status information instance codebooks to be used by the UE, wherein the time status information instance identifier is associated to a time status information instance in the particular time status information instance codebook. In one embodiment, the method further comprises receiving, from another network node, either the one or more time status information instance codebooks or one or more respective identifiers of the one or more time status information instance codebooks.

In one embodiment, the network node is a core network node. In one embodiment, the method further comprises providing, to a RAN node, either the one or more time status information instance codebooks or one or more respective identifiers of the one or more time status information instance codebooks. In one embodiment, the method further comprises dynamically generating the one or more time status information instance codebooks.

In one embodiment, the network node is a network node in a cellular communications system, and each time status information instance in each of the one or more time status information instance codebooks comprises information about time synchronization status of the cellular communications system.

In one embodiment, the method further comprises determining that the UE is in need of a new time status information instance codebook and, responsive to determining that the UE is in need of a new time status information instance codebook, providing one or more new time status information instance codebooks to the UE.

In one embodiment, the network node is a network node in a cellular communications system, and each time status information instance in each of the one or more time status information instance codebooks comprises information about a time synchronization status of the cellular communications system.

In one embodiment, each time status information instance in the set of possible time status information instances comprises any one or more of the following: information about a divergence of a timing of the wireless network from UTC and information about a degradation of a timing source of the wireless network.

In one embodiment, at least one time status information instance in the set of possible time status information instances comprises one or more clock quality metrics that reflect a current timing synchronization status of the wireless network. In one embodiment, the one or more clock quality metrics comprise any one or more of the following: timing synchronization state, timing synchronization source type, clock quality descriptor, clock accuracy, traceability to UTC, and frequency stability.

In one embodiment, at least one time status information instance in the set of possible time status information instances comprises either an acceptable indication or a not acceptable indication.

Corresponding embodiments of a network node are also disclosed. In one embodiment, a network node is adapted to provide, to a UE, one or more time status information instance codebooks each comprising a set of possible time status information instances associated to respective time status information instance identifiers.

In one embodiment, the network node comprises processing circuitry configured to cause the network node to provide the one or more time status information instance codebooks to the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a procedure involving a core network node (optional), a Radio Access Network (RAN) node, and a User Equipment (UE) in which the UE obtains and uses a time status information instance codebook(s) in accordance with embodiments of the present disclosure;

FIG. 2 is a flow chart that illustrates the operation of a UE to re-acquire time status information instance codebook(s) in accordance with one embodiment of the present disclosure;

FIG. 3 is a flow chart that illustrates the operation of a network node (e.g., a core network node or a RAN node) to provide new time status information instance codebook(s) to a UE in accordance with one embodiment of the present disclosure;

FIG. 4 is a flow chart that illustrates the operation of a UE to handle an error in accordance with one embodiment of the present disclosure;

FIG. 5 shows an example of a communication system in accordance with some embodiments;

FIG. 6 shows a UE in accordance with some embodiments;

FIG. 7 shows a network node in accordance with some embodiments;

FIG. 8 is a block diagram of a host, which may be an embodiment of the host of FIG. 5, in accordance with various aspects described herein;

FIG. 9 is a block diagram illustrating a virtualization environment in which functions implemented by some embodiments may be virtualized;

FIG. 10 shows a communication diagram of a host communicating via a network node with a UE over a partially wireless connection in accordance with some embodiments; and

FIG. 11 is a reproduction of Figure A.1.1-1 from 3^{rd} Generation Partnership Project (3GPP) Technical Report (TR) 23.700-25 v18.0.0.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the present disclosure, embodiments of a solution for providing a User Equipment (UE) timing synchronization status in a secure and resource efficient manner are disclosed.

According to the conclusion for Key Issue #1 described in 3^{rd} Generation Partnership Project (3GPP) Technical Report (TR) 23.700-25v2.0.0, the status report is provided to the UE via a Radio Resource Control (RRC) dedicated message when the UE is in RRC_CONNECTED state. This requires that, in order to receive a status report, the UE must be in the RRC_CONNECTED state. 3GPP TR 23.700-25 Annex A proposes alternatives (1 and 2) on how the UEs that are in RRC_IDLE or RRC_INACTIVE state can determine whether the status of the time synchronization has changed and move to RRC_CONNECTED state in order to receive the status update.

Alternative 1(b) in 3GPP TR 23.700-25 includes an option to use Report Identifier (ID) included in a System Information Block (SIB) 9 (i.e., “SIB9”) message, which the UE will use as index to select from a predefined and/or standardized list of time synchronization characteristics. The index is known to the UE and Next Generation Radio Access Network (NG-RAN). This allows the UE to determine by itself the status without the need to move into RRC_CONNECTED state or whether there is a need to re-connect in order to get the status update). Note as agreed in 3GPP System Architecture (SA) Working Group 2 (WG2), the status report can be provided in two ways: actual metrics of relevant time synchronization parameters or an “acceptable/not acceptable” indication.

Note that “clock quality” is a term used throughout the present disclosure to refer to clock characteristics such as accuracy, class, etc.

There currently exist certain challenge(s). A UE using the time synchronization service is to be informed about the service status when necessary. The challenge is to provide this information (a) in a secure manner only to UEs that have a valid subscription to that service and (b) in a resource efficient manner.

In currently discussed solutions, the status information is provided to UEs that are in RRC_CONNECTED state. This ensures that only UEs with a valid subscription will receive this information and that it is provided in a secure manner. However, there are costs to that approach as (1) the UEs in IDLE state will have to perform the Random Access procedure which can impact service of other UEs (and UEs in INACTIVE state will need to connect as well), especially when a large number of UEs that use the service are in same coverage area and may not be already in CONNECTED state and (2) using RRC_CONNECTED state decreases the Radio Access Network (RAN) capacity to serve other UEs.

The existing solution in 3GPP TR 23.700-25, Annex A.1.1, alternative 1(b) could lead to misuse of the information or business threat since part of the clock quality information is known (as information is pre-defined or standardized).

Certain aspects of the disclosure and their embodiments may provide solutions to these or other challenges. Embodiments of the solution disclosed herein provide UEs with an individual codebook associated with the time synchronization service(s), e.g., via either Non-Access Stratum (NAS) or RRC messages. The codebook allows UEs to interpret the information broadcasted over the radio interface with associated services and, if the UE is not receiving the service in question, UEs in IDLE or INACTIVE states do not transition to RRC_CONNECTED state to receive additional information.

Embodiments of the present disclosure provide UEs, without exposing details of network sensitive information openly, information on how to interpret generic information into specific service and thus reduce unnecessary UE connection to the network. Embodiments of the present disclosure may also allow potential dynamical change of a codebook, for example, based on Application Function information relevant to the specific service, thus making it more robust and efficient from network resource usage.

Certain embodiments may provide one or more of the following technical advantage(s). Embodiments of the present disclosure may reduce the number of UEs in RRC_IDLE/INACTIVE state that need to move to the RRC_CONNECTED state at the same time after receiving an indication in SIB9 about changes in time synchronization status.

### Providing the Codebook to the UE

In one embodiment, the network (i.e., a network node such as, e.g., a core network node or RAN node) sends a set of possible time status information instances (or simply “time information's”) to a UE. The set of possible time status information instances may be referred to as a “codebook” or “time status information instance codebook”. Each possible instance is associated with an identifier. The identifier may be sent explicitly or implicitly. In case of explicit signaling, the network indicates for a time status information instance the associated identifier. Another approach is that an implicit approach is applied where e.g. the index is determined based on the order or a particular time status information within a list of time status information instances. The index may for example be an alphanumerical value.

Note that, as described in the Background section above, time status information may include, e.g., divergence from Coordinated Universal Time (UTC) and 5GS network timing source degradation). As another example, as described in the example implementation described below, time status information (i.e., a time status information instance) may include, e.g., clock quality metrics that reflect the network's current timing synchronization status (e.g., synchronization state (“locked”, “holdover”, “freerun”), source type (e.g., PTP, GNSS, other), clock quality descriptor (e.g., clock class, clock accuracy, GNSS Rx time error), clock accuracy, traceability to UTC, frequency stability, etc.), or an acceptable or not acceptable indication.

The codebook may be sent to the UE registered in the network from a RAN node (e.g., a gNodeB (gNB)) in the network, e.g. using the RRC protocol where it is stored (even when UE enters RRC_IDLE) until a new codebook is provided or it is deleted, e.g. by explicit signaling from the network, invalidation of validity conditions provided by the network (e.g. time or/and location validity condition(s)), or the like.

Another possible way to send the codebook is from a core network node. For example, the codebook may be sent to the UE from an Access and Mobility Management Function (AMF) or Time Sensitive Communication and Time Synchronization Function (TSCTSF), where in the latter this information is sent via the AMF. The core network node may send the codebook using NAS signaling, e.g. during registration procedure in the Registration Accept message. The UE stores the codebook until a new codebook is provided or it is deleted, e.g. by explicit signaling from the network, invalidation of validity conditions provided by the network (e.g. time or/and location validity condition(s), or the like. If the codebook considers the Clock Quality Reporting Control Information (see, e.g., 3GPP TR 23.700-25, clause 8.5) as described below in the subsection entitled “Dynamic Generation of a Codebook”, which may be provided after registration, or if the relevant requirement parameters are updated during operation of the service, then the network sends a new codebook to the UE (if the current codebook no longer applies or its validity time expires) or provides a reference to another existing codebook. Provision of multiple codebooks are possible and described in the next subsection. If the UE moves into a different tracking area, then a new codebook may be sent as described below in the subsection entitled “Re-acquisition of the Time Information”.

### Multiple Codebook Approach

If the network deployment results in different codebooks being used, the network (e.g., the core network node or RAN node) may provide multiple time status information instance codebooks to the UE. In another scenario, UEs are provided different codebooks as a function of their service requirements and/or subscription level, e.g. one subscription may provide enhanced levels of status information compared to another subscription level (e.g., ‘golden’, ‘silver’, etc.).

The network (e.g., the core network node or RAN node) sends a set of codebooks to the UE, i.e. multiple and different codebooks. Each codebook in this set is referred to herein as a codebook instance. Each codebook instance is associated with an identifier (also referred to herein as a “codebook identifier”). The identifier may be sent to the UE explicitly or implicitly. In case of explicit signaling, the network indicates for a codebook instance the associated identifier. Another approach is that an implicit approach is applied where e.g. the index is determined based on the order or a particular codebook within a list of codebook instances. The index may for example be an alphanumerical value.

The codebook may be sent to the UE from a RAN node (e.g., a gNB) in the network, e.g. using the RRC protocol or from a core network node (e.g., AMF) using NAS procedure. In one embodiment, the codebook(s) are sent to UEs who have subscription to the time synchronization service.

The decision of what time status instance codebook(s) to send to the UE can, e.g. be dependent on which codebooks are valid in a particular area. In this case, the core network (e.g., core network node) can be configured with information about what codebooks are to be used in a particular Tracking Area(s) or list(s) of cells. The core network (e.g., core network node) can be configured by Operations and Management (O&M) system or receive this information from the RAN when setting up the RAN/Core Network (CN) interface, e.g. in the Next Generation (NG) interface setup procedure.

Alternatively, codebooks can be dynamically generated by a core network node, e.g., Application Function (AF), TSCTSF, or AMF, considering the configuration of time synchronization services currently governed by the core network node. The means to generate dynamic codebook are described below in the subsection entitled “Dynamic Generation of a Codebook.”

A network node (e.g. the gNB or the AMF) indicates to the UE which codebook(s) apply. Example means to provide codebooks to the UE in NAS or RRC protocol are described above in the subsection entitled “Providing the Codebook to the UE.”

### Dynamic Generation of a Codebook

To generate a codebook, a core network node (e.g., TSCTSF or AMF) may consider the following aspects:
Network's time synchronization performance information as reported by a RAN node (e.g., a Next Generation RAN (NG-RAN) node and/or a User Plane Function (UPF) to the TSCTSF. This information may include the following elements, e.g., synchronization state (“Locked”, “Holdover”, “Freerun”), source type (e.g., “PTP”, “GNSS”, “other”), clock quality descriptor (e.g., “clockClass”, “ClockAccuracy”, “gnss-rx-time-error”)
Configurations/parameters of the current time synchronization services managed by the core network node, e.g., Uu time synchronization error budget, UE subscription data, including “Clock Quality Reporting Control Information”, Spatial Validity Condition, Temporal Validity Condition. Note that these parameters may be provided for time synchronization services based on (generalized) Precision Time Protocol ((g)PTP) time distribution and/or 5G Access Stratum (AS) time distribution (3GPP TS 23.502, Rel18, clause 4.15.9.3 and 4.15.9.4). The latter is also referred to as an “ASTI service”. 5G Access Stratum-based Time Distribution and (g)PTP-based Time Distribution are defined in 3GPP TS 23.501 as follows:
   5G Access Stratum-based Time Distribution: A time synchronization distribution method that is used by an NG-RAN to provide the 5GS time to the UE(s) over the radio interface using procedures specified in TS 38.331.
   (g)PTP-based Time Distribution: a method to distribute timing among entities in a (g)PTP domain using PTP messages generated by a GM (in the case the GM is external to 5GS) or by 5GS (in the case the 5GS acts as a GM for a given (g)PTP domain). Possible dependencies between (g)PTP-based Time Distribution and 5G Access Stratum-based Time Distribution are described in clause 5.27.1. The synchronization process is described in clause 5.27.1 and follows the applicable profiles of IEEE Std 802.1AS or IEEE Std 1588.
Input from Application Function
UE location as a codebook may be provided per a tracking area or for a list of cells.

NG-RAN node may provide a “Time Accuracy Class” information to the core network node, to indicate which time synchronization accuracy it supports. The core network node, when constructing the codebook or requirement, takes the Time Accuracy Class information into account.

The codebook can be generated dynamically based on the abovementioned aspects, and then re-generated when/if any change of a time synchronization service requires a new codebook or a set of codebooks. Furthermore, a codebook may include a validity time, exceeding which a new codebook would need to be provided, and it may include a dedicated index/instance indicated that a UE needs to move to RRC_CONNECTED state in order to receive a time synchronization status information. A codebook generation is performed at a core network node that has suitable knowledge for doing so, i.e., TSCTSF or AMF.

### Providing the Codebook to the RAN Node

In one embodiment, a RAN node (e.g., a gNB for this discussion) is provided the time status information instance codebook(s). The codebook(s) may be beneficial to the gNB for at least the following two reasons:
to provide the correct time status information identifier to the UE; or
in case the codebook is sent to the UE by the gNB, the gNB would also need to have the codebook.

The codebook may be indicated (reference to that codebook) to the gNB for the case where the gNB is configured (e.g., by O&M) with all codebooks that can be referenced by the core network. In that case, the core network node is aware of what codebooks are applicable to that gNB. Alternatively, the gNB can be provided with the codebooks, i.e. the actual content of the applicable codebooks from a core network node such as, e.g., an AMF or another core network node via an AMF. As another option, the gNB is configured (e.g., by O&M) with the codebooks that are valid for that gNB or cells configured on that gNB.

In one embodiment, codebooks are signaled to gNB in non-UE associated signaling, such as during NG Setup/reconfiguration procedures.

In another embodiment, codebooks are signaled to gNB via UE associated signaling, such as during Initial Context Setup/modification procedures, or Protocol Data Unit (PDU) session resource management procedures.

In another embodiment, codebooks are signaled to the gNB via paging procedure.

The gNB would determine the current time status information and indicate that information to the UE by means of indicating the index to the appropriate information in the codebook to the UE.

gNBs are synchronized with the indices referring to the codebooks, e.g., via Xn Interface or NG interface when no Xn interface exists between the two nodes. This can be implemented, for example, via resource coordination procedure. The synchronization can be alternatively performed via OAM.

### Indicating Currently Applicable Time Status Information

The network indicates to the UE which time status information instance in the codebook instance is currently applicable. It is indicated by referring to the index. The UE knows the currently applicable time status information by the index that the gNB has indicated, e.g. if the gNB indicates index 17, the UE would apply the time status information associated with the value 17.

Status type “acceptable/not acceptable”
Option 1: When the service for a UE requires that the status shall be provided via, for example, “acceptable” or “not acceptable” indication, then the UE may compare with previous status situation (previous index) and if there is a change then the UE will move into RRC_CONNECTED state to receive the actual status report (in the form acceptable/not acceptable as applicable for this UE). That is, no codebook is required. However, multiple UEs moving into RRC_CONNECTED state may happen.
Option 2: the codebook contains index and corresponding set of time sync characteristics, just as regular type of status, i.e., providing actual metrics. The UE can determine by itself the status. Since the codebook is not broadcasted, the risk for misuse is covered.
Option 3: Only the network (e.g., TSCTSF, AMF, gNB) knows the actual time synchronization characteristics that corresponds to an index. In this case, gNB will have a codebook for that UE that contains all information: indexes, corresponding time sync characteristics, and corresponding “acceptable/not acceptable” value. Before the codebook is delivered to the UE, gNB will provide a modified codebook to the UE which does not contain the time sync characteristics. The codebook for such UE only contains a list of indexes and their corresponding value: acceptable or not acceptable.

If RRC signaling is used, in one embodiment, DRB (Data Radio Bearer) is used to convey the information to UE. In another embodiment, there is no need to setup the DRB, the RRC SRB (Signaling Radio Bearer) is used.

This may be indicated by the gNB to the UE. It can be indicated in system information. For example, the network may broadcast the index of the currently applicable time status information.

If multiple codebooks are used in the network, the gNB can additionally indicate in the system information the reference to codebook that is applicable in the current cell. If different codebooks are provided for the same area, the system information in the cell can provide multiple references to different codebooks and the associated index values of the currently applicable time status information in each referenced codebook.

### Re-Acquisition of the Time Information

In different regions of the network, different codebooks may be applicable. For example, one codebook may be applicable in a first tracking area and another codebook applicable in another tracking area.

When/if a UE moves between tracking areas, the UE may therefore need to re-acquire the codebook. The UE may determine that the tracking area that the UE is in has changed and in response to this initiate a procedure to acquire a new codebook. One approach is that the UE indicates to the network that the UE needs to get a new codebook. Another approach is that the network determines that the UE has changed area (e.g. changes tracking area, which could be determined by the network by that the UE is doing a tracking area update procedure), and in response to this the network provides a new codebook to the UE.

The UE can also identify the need to acquire a new codebook when an unknown code book reference is received in the system information or when the validity time has expired for the existing codebook.

### Error Case

When the index provided to the UE via SIB message is not found in the codebook available at the UE, then the UE will move into RRC_Connected state in order to receive its status report via regular unicast RRC message.

### Further Description

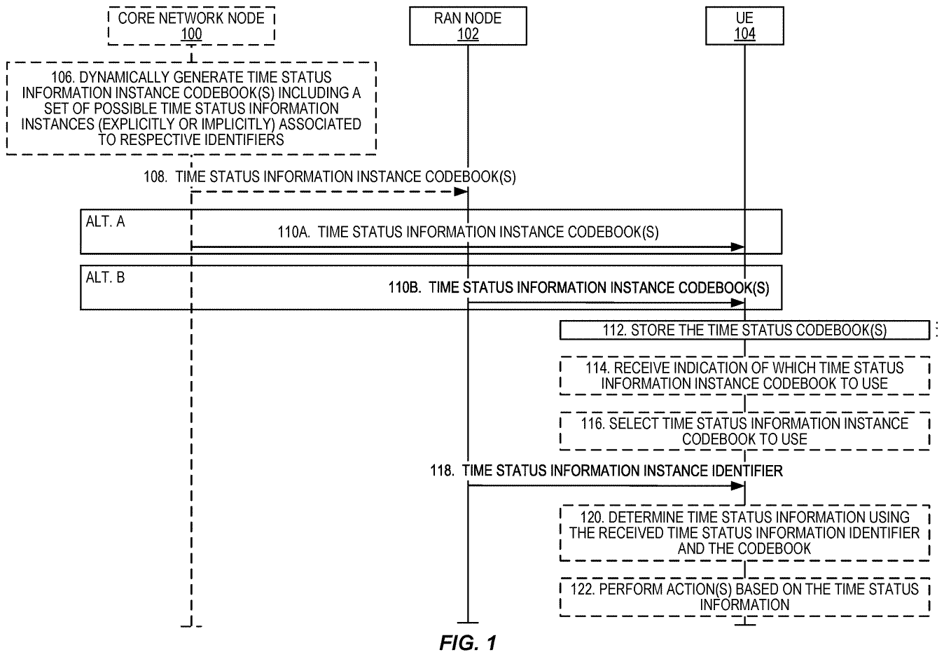

FIG. 1 illustrates a procedure involving a core network node 100 (optional), a RAN node 102, and a UE 104 in which the UE 104 obtains and uses a time status information instance codebook(s) in accordance with at least some of the embodiments described above. Optional elements and steps are represented by dashed lines/boxes. The core network node 100 may be, for example, an AMF. The RAN node 102 may be, for example, a gNB. As illustrated, in some embodiments, the core network node 100 dynamically determines one or more time status information instance codebooks (step 106). Details of how the core network node 100 dynamically determines the one or more time status information instance codebooks can be found above, e.g., in the subsection entitled “Dynamic Generation of a Codebook.” In some embodiments, the core network node 100 provides one or more time status information instance codebooks (e.g., the one or more time status information instance codebooks dynamically generated in step 106) to the RAN node 102 (step 108). Details about providing the one or more time status information instance codebooks to the RAN node 102 can be found above, e.g., in the subsection entitled “Providing the Codebook to the gNB.” Note that, as discussed above, the core network node 100 may signal the one or more time status information instance codebooks to the RAN node 102 or signal an associated codebook identifier (e.g., index) to the RAN node 102.

In one embodiment (referred to in FIG. 1 as Alternative A), the core network node 100 provides, to the UE 104, one or more time status information instance codebooks, as described above (step 110A). The one or more time status information instance codebooks may be, e.g., the one or more time status information instance codebooks dynamically generated by the core network node 100 in step 106 and sent from the core network node 100 to the RAN node 102 in step 108. As discussed above, each time status information instance codebook includes a set of possible time status information instances explicitly or implicitly associated to respective identifiers (referred to herein as “time status information instance identifiers” or “indices”). The time status information instance identifiers may be explicitly signaled from the core network node 100 to the UE 104 (e.g., included in the codebook(s)) or implicitly signaled from the core network node 100 to the UE 104 (e.g., via the ordering of the possible time status information instances in the set of possible time status information instances). Further details about providing a time status information instance codebook to the UE 102 can be found above, e.g., in the subsection entitled “Providing the Codebook to the UE.” Further details above providing multiple time status information instance codebooks to the UE 102 can be found above, e.g., in the subsection entitled “Multiple Codebook Approach.”

In another embodiment (referred to in FIG. 1 as Alternative B), the RAN node 102 provides, to the UE 104, one or more time status information instance codebooks, as described above (step 110B). The one or more time status information instance codebooks may be, e.g., the one or more time status information instance codebooks received by the RAN node 102 from the core network node 100 in step 108. As discussed above, each time status information instance codebook includes a set of possible time status information instances explicitly or implicitly associated to respective identifiers (referred to herein as “time status information instance identifiers” or “indices”). The time status information instance identifiers may be explicitly signaled from the RAN node 102 to the UE 104 (e.g., included in the codebook(s)) or implicitly signaled from the RAN node 102 to the UE 104 (e.g., via the ordering of the possible time status information instances in the set of possible time status information instances). Further details above providing multiple time status information instance codebooks to the UE 102 can be found above, e.g., in the subsection entitled “Multiple Codebook Approach.”

At the UE 104, the UE 104 stores the received time status information instance codebook(s) (step 112). If there are two or more codebooks, the UE 104 operationally receives an indication from a network node (e.g., the RAN node 102) of the one of the two or more time status information instance codebooks to be used by the UE 104 (step 114) and selects one of the two or more time status information instance codebooks to be used by the UE 104 based on the received indication or based on one or more criteria, as described above (step 116). Further details about how the UE 104 selects which codebook to use in step 114 or receives the indication of which of codebook to use are described above, e.g., in the subsections entitled “Multiple Codebook Approach” and “Indicating Currently Applicable Time Status Information.”

Sometime thereafter, the RAN node 102 transmits a time status information instance identifier that is associated to the desired time status information to be communicated to the UE 104 (step 118). The UE 104 receives the time status information instance identifier and uses the (selected) time status information instance codebook to determine the time status information instance that is associated to the received time status information instance identifier (step 120). In other words, the UE 104 determines the time status information instance in the codebook that is indicated by the received identifier. The UE 104 may then perform one or more actions based on the time status information instance indicated by the received identifier (step 122). These actions may include, for example, any action that is conventionally performed by a UE based on time status information received in a time status report using the existing connected mode procedure.

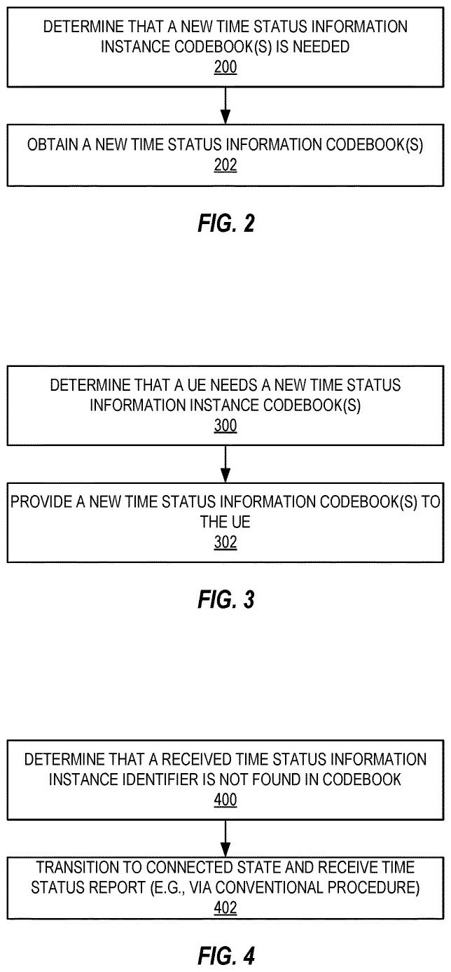

FIG. 2 is a flow chart that illustrates the operation of a UE (e.g., the UE 104) to re-acquire time status information instance codebook(s) in accordance with one embodiment of the present disclosure. As illustrated, the UE determines that a new time status information instance codebook(s) is needed (step 200). Responsive to determining that a new time status information instance codebook(s) is needed, the UE obtains a time status information instance codebook(s) (step 202). Details about how the UE determines that a new time status information instance codebook(s) is needed and how the UE then obtains a new time status information instance codebook(s) can be found above, e.g., in the subsection entitled “Re-acquisition of the Time Information.”

FIG. 3 is a flow chart that illustrates the operation of a network node (e.g., the core network node 100 or the RAN node 102) to provide new time status information instance codebook(s) to a UE (e.g., the UE 104) in accordance with one embodiment of the present disclosure. As illustrated, the network node determines that a UE needs new time status information instance codebook(s) (step 300). Responsive to determining that the UE needs a new time status information instance codebook(s), the network node provides, to the UE, a new time status information instance codebook(s) (step 302). Details about how the network determines that the UE needs a new time status information instance codebook(s) and how the network node then provides a new time status information instance codebook(s) to the UE can be found above, e.g., in the subsection entitled “Re-acquisition of the Time Information.”

FIG. 4 is a flow chart that illustrates the operation of a UE (e.g., the UE 104) to handle an error in accordance with one embodiment of the present disclosure. As illustrated, the UE determines that a received time status information instance identifier (e.g., the identifier received in step 118) is not found in the respective codebook (step 400). Responsive to determining that the received time status information instance identifier is not found in the respective codebook, the UE transitions to connected state (e.g., RRC_Connected) and receives a time status report, e.g., using the existing connected mode procedure (step 402). Details about the procedure of FIG. 4 can be found above, e.g., in the subsection entitled “Error Case.”

One example implementation of at least some aspects of the embodiments described above is show below as changes to 3GPP TR 23.700-25 v 18.0.0, where additions are shown by underlining and deletions are shown by the use of double brackets around the deleted text.

### ***** START OF CHANGES TO 3GPP TR 23.700-25 *****

### 8.5 Conclusion for KI #1: 5GS Network Timing Synchronization Status and Reporting

The following bullet points summarize the principles for the way forward:
Detecting and reporting RAN and UPF timing synchronization status to TSCTSF.
NG-RAN and UPF/NW-TT can detect timing synchronization degradation/failure/improvement locally.

NOTE 1: The detection is performed based on information provided by time synchronization protocols used in the transport network for both RAN and UPF, or, in the case of NG-RAN, using information provided by a local GNSS receiver. However, in any case, the details on how exactly NG-RAN/UPF detects timing synchronization degradation/failure/improvement locally are beyond the scope of 3GPP.

Two options are defined for the TSCTSF to detect the timing synchronization status information of RAN and UPF/NW-TT:
1) TSCTSF may receive network timing synchronization status information of RAN and UPF/NW-TT directly from OAM.
2) Alternatively, TSCTSF may receive network timing synchronization status information of RAN and UPF/NW-TT using control plane signalling at node level:
   For UPF/NW-TT case the TSCTSF may use UMIC.
   For NG-RAN case the TSCTSF may obtain NG-RAN network timing synchronization status information via the AMF (i.e. AMF uses NGAP signalling to configure the NG-RAN reporting).

The network timing synchronization status information from RAN or UPF/NW-TT can contain the following parameters: node's synchronization state, node's synchronization performance, primary source description, and primary source event.

Editor's note: How to support additional methods (NGAP, control plane signalling, etc.) to obtain timing synchronization status from NG-RAN requires RAN feedback.
UE determining that the RAN timing synchronization status changed using:
SIB broadcast information to enable UEs in RRC_IDLE and RRC INACTIVE and in the case of RRC CONNECTED UEs, dedicated RRC signalling, to enable UEs to determine that:
   the timing synchronization status of the cell that the UE is camping on has changed;
   the timing synchronization status of the new cell the UE is camping on after cell reselection is different compared to the timing synchronization status of the cell that the UE was previously camping on.
If the UE has determined that the RAN timing synchronization status has changed and the UE has been requested by the TSCTSF to connect to the network in the case the RAN timing synchronization status changes, the UE performs a registration (if the UE is in RRC_IDLE) or the UE Triggered Connection Resume in RRC Inactive procedure (if the UE is in RRC_INACTIVE).
Information to be broadcasted via SIB to the UEs in RRC_IDLE or RRC_INACTIVE consists of a Report ID which contains Cell Group ID and Event ID, according to Alternative 1.1(c) in clause A.1.1. This information included in the SIB is optional.

Based on this information, the UE can determine its status using codebooks, or in case of error the UE may require to transition to RRC_CONNECTED in order to explicitly receive a status report via unicast RRC message.

NOTE 2: UEs in RRC_CONNECTED can be provided with more accurate service, given that propagation delay compensation methods can only be applied in RRC_CONNECTED state. The use of SIB messages for UEs in RRC_IDLE and RRC_CONNECTED is susceptible to malicious insertions that can change the behavior of the UE, either by multiple UEs transitioning simultaneously and unnecessarily into RRC_CONNECTED or by receiving wrong status information. Therefore it is up to the network operator to keep UEs which require time synchronization status reports always in RRC_CONNECTED or to limit the case to local/private threat-free scenarios.

[[Editor's note: The details of which existing/new SIB information the UE uses to determine that the RAN timing synchronization status has changed is FFS and will be coordinated with RAN WGs.]]
Providing RAN timing synchronization status information to the UE in RRC Connected state:

[[Editor's note: Providing RAN timing synchronization status information to the UE in RRC Idle and RRC Inactive state is FFS.]]
If a UE is subscribed for Access Stratum Time Synchronization (ASTI) in the UDM (see clause 8.6), then the “Access and Mobility Subscription data” may additionally contain the following clock quality reporting control information:
   Clock quality detail level: indicates whether and which clock quality information to provide to the UE and can take one of the following values: clock quality metrics or acceptable/not acceptable indication;
   Clock quality acceptance criteria for the UE (if the clock quality level equals “acceptable/not acceptable indication”: the clock quality acceptance criteria for the UE (e.g. acceptable clock accuracy, acceptable frequency stability, etc.).

NOTE 3: Whether and which clock quality information to provide to the UE depends on the needs of the time service consumer (referred to as client network operator hereafter). Therefore, the clock quality detail level and clock quality acceptance criteria are based on the parameters and their values specified in the agreement between the 5G network operator and the client network operator. The clock quality acceptance criteria refer to the quality with which 5G access stratum time needs to be delivered to and received by the UE (i.e. also considering propagation delays). Additional inaccuracies in the UE, e.g. if the 5G access stratum time is delivered to devices attached to the UE, are not included in the clock quality acceptance criteria because they are assumed to be budgeted by the client network operator when agreeing the required clock accuracy with the 5G network operator.
If an AF requests Access Stratum Time Synchronization (ASTI) for a UE, then the AF may provide clock quality reporting control information to TSCTSF. TSCTSF provides the clock quality reporting control information to AMF.
When AMF provides the 5G access stratum time distribution indication and the Uu time synchronization error budget to NG-RAN, AMF also includes the clock quality reporting control information.
Based on the clock quality reporting control information received from AMF, RAN reports its timing synchronization status to the UE using unicast RRC:
   If clock quality detail level is set to “clock quality metrics”, then the RAN provides clock quality metrics to the UE that reflect its current timing synchronization status. Clock quality metrics refers to information such as clock accuracy, traceability to UTC, frequency stability, etc.
   If clock quality detail level is set to “acceptable/not acceptable indication”, then the RAN provides an acceptable indication to the UE if the RAN's timing synchronization status matches the acceptance criteria received from AMF; otherwise RAN indicates “not acceptable” to the UE.
   The UE will be provided with the following clock quality metrics: synchronization state (“Locked”, “Holdover”, “Freerun”) [optional], source type (e.g. “PTP”, “GNSS”, “other”) [optional], clock quality descriptor (e.g., “clockClass”, “ClockAccuracy”, “gnss-rx-time-error”) [mandatory], or these parameters will be used by RAN to determine whether the clock quality is acceptable. For the latter case, NG-RAN transfers this status (acceptable/not acceptable) to the UE.

[[Editor's note: Which clock quality metrics (e.g. clock accuracy, traceability to UTC, frequency stability) will be provided to the UE and will be used to determine whether the clock quality is acceptable or not is FFS.]]
When determining the clock quality metrics for a UE and when determining whether clock quality is acceptable or not acceptable for a UE, RAN considers whether propagation delay compensation is performed.

NOTE 4: Clock quality metrics and the acceptable/not acceptable indication refer to the quality with which 5G access stratum time is delivered to and received by the UE (i.e. also considering propagation delays). In addition, the UE can, for example, update clock quality metrics to reflect internal inaccuracies in the UE before providing the clock quality metrics to devices connected to the UE.
Determining UEs impacted by RAN timing synchronization status degradation/improvement:
   TSCTSF subscribes to receive notifications for UE presence in Area of Interest information (Area of Interest is set to a list of RAN node IDs that have the same RAN timing synchronization status) from AMF for UEs that AF requested time synchronization for or which are configured for (g)PTP-based time synchronization based on subscription.
   When activating time synchronization for a UE, TSCTSF requests the UE to connect to the network via AMF (i.e. to perform a registration if the UE is in RRC_IDLE or the UE Triggered Connection Resume in RRC Inactive (if the UE is in RRC_INACTIVE) in the case when the UE later detects that the RAN timing synchronization status has changed while the UE is in RRC_IDLE or RRC_INACTIVE.
   TSCTSF correlates information about impacted RAN nodes and the UE location information received from AMF to determine the UEs impacted by RAN timing status degradation/failure/improvement.

Editor's note: Whether alternatively NG-RAN can be responsible for determining the impacted UE(s) and sending the NG-RAN timing synchronization status reports to the AMF via NG-AP signalling, together with the impacted UE(s) is FFS.
Determining UEs impacted by UPF timing synchronization status degradation or improvement (only for the case when UPF/NW-TT is involved in providing time information to DS-TT):
TSCTSF determines the UEs for which an impacted UPF/NW-TT is configured to send (g)PTP messages.
Informing AFs about network timing synchronization status degradation or improvement:
If TSCTSF has determined UEs impacted by RAN or UPF timing synchronization status degradation or improvement or failure then TSCTSF informs the AF about the timing synchronization status for those UEs if the AF was the requester of the time synchronization service.
The AF may subscribe to time synchronization service status for a UE (or group of UEs) for which the AF requests or has requested time synchronization service (for ASTI or (g)PTP services).
For the subscribed AFs the TSCTSF provides time synchronization service status.
The TSCTSF may perform the following:
For AFs that requested ASTI service, the TSCTSF may indicate whether it can support the ASTI service or not as per the requested criteria.
For AFs that requested PTP service, the TSCTSF may indicate whether it can support the PTP service or not as per the requested criteria.
For AFs that subscribe for ASTI/PTP service status update (i.e. change in support status), the TSCTSF may provide notification towards the AF when there is a change in support status.
Deactivating/reactivating/updating time synchronization services based on RAN/UPF timing synchronization status changes:
PTP case: For UEs that are part of a PTP instance and which are impacted by RAN or UPF time synchronization status degradation or improvement:
   If TSCTSF determines that the Time synchronization error budget provided by AF can still be met, then TSCTSF may update the clockQuality information sent in Announce messages (see clause 7.6.2 of IEEE 1588 [8]) for the PTP instance using existing procedures and existing PMIC/UMIC information. The handling of Announce messages follows existing procedures as described in TS 23.501 [2].
   If TSCTSF determines that the Time synchronization error budget provided by AF cannot be met (see above) then TSCTSF informs the AF about the intention to temporarily remove the UE/DS-TT from the PTP instance and performs the action using existing procedures in clause K.2.2.1 and clause K.2.2.4 of TS 23.501 [2]) after receiving the confirmation. If the AF declines the intention, the TSCTSF keeps the service active.
   If TSCTSF determines that the Time synchronization error budget provided by AF can be met again then TSCTSF adds the DS-TT PTP port to the PTP instance again and also re-activates the Grandmaster functionality.
ASTI case: TSCTSF updates the access stratum time distribution indication to “enable” or “disable” and forwards the attribute to the serving NG-RAN nodes for the impacted UEs via AMF depending on whether the Time synchronization error budget can or cannot be met (following Rel-17 operations as described in clause 4.15.9.4 of TS 23.502 [3]). However, before updating the access stratum time distribution indication from “enable” to “disable”, the TSCTSF needs to inform the AF (if the ASTI service was activated based on the AF request) about the intention and receive the confirmation; otherwise, the TSCTSF keeps the indication unchanged.

### ***** START OF NEXT CHANGE TO 3GPP TR 23.700-25 *****

### A.1.1 Alternative 1: gNB Provides a Reference REport ID within SIB

In this alternative when there is a new RAN timing synchronization status report available at the gNB, the gNB includes in the SIB a status report ID as a notification for the UEs reading the SIB. The report ID can be an optional integer information element. This report ID enables the UE to know there is new information available at the NG-RAN that is not available locally at the UE. There are three options for the UE to determine RAN timing synchronization status information with the report ID:
a) The UE can actively retrieve the RAN timing synchronization status information from the network by entering RRC_Connected. In order to determine if a report ID is associated to a new report, the UE uses status report ID and the SIB information to identify the serving gNB in the cell. For report ID composition, the report ID is constructed from a pre-agreed (known values at the UE and network side) set of values. The report ID is constructed from a cell group ID and event ID elements:
   Cell group ID is an integer allocated by the gNB that identifies a group of cells controlled by the same gNB.
   Event ID is an integer value.
b) Report ID is an index that maps to a pre-defined and/or standardized time synchronization characteristics thus the UE can automatically determine this without having to move to RRC_CONNECTED state. The report ID is composed by one integer which values are standardized or operator defined that are known at the UE and the NG-RAN node.

To limit the possible permutations of report IDs, in addition to the report ID mapping to time synchronization characteristics, the UEs or AFs may receive additional time synchronization characteristics via SLA or dedicated signalling. The decision depends on the time synchronization characteristics that should be considered. For example, the following parameters can be considered: Lock state, Parent Time Source, Clock class, Clock stability, Clock identifier, Physical layer frequency availability, Holdover specification
c) Report ID is an index that maps to a set of time synchronization characteristics which is part of a list or codebook. This set of time synchronization characteristics indicates the current status of the service which the UE can use to determine this without having to move to RRC_CONNECTED state. The codebook is generated by the TSCTSF The codebook may be sent to the registered UE with a reference ID for the codebook from a gNB in the network, e.g. using the RRC protocol (unicast messages). Codebooks are provided to RAN via OAM.
Codebooks can be generated dynamically based on time synchronization subscription data for UE, AF request, network capabilities and performance. It is assumed that the TSCTSF received this information before generating codebooks. How a codebook is generated is up to implementation. The codebooks are sent to UEs that have subscription to the time synchronization service during registration. When status should be provided in terms of Acceptable/Not acceptable, then the respective codebook will contain the indexes and their corresponding value for: acceptable or not acceptable.

An overall procedure for SIB including a reference report ID is illustrated in Figure A.1.1-1.

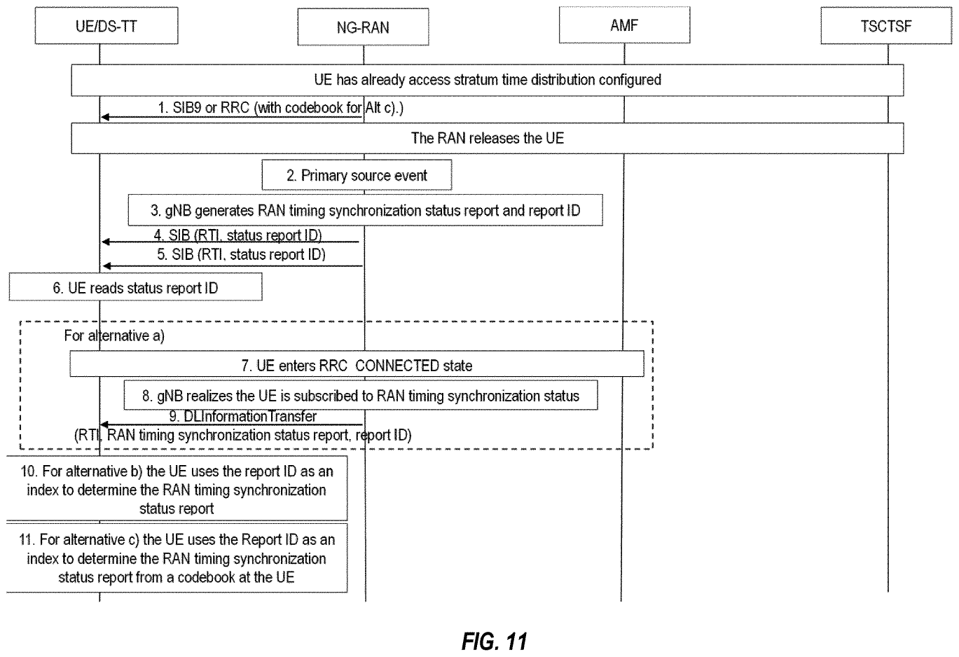

### REPRODUCED HEREIN AS SEE FIG. 11

### Figure A.1.1-1: Procedure for gNB Provisioning Status Report ID in SIB

1. The UE has received reference time information using unicast RRC or SIB9. For alternative c), the unicast RRC message may contain a codebook and a reference ID for the codebook. The RAN releases the UE to RRC Inactive or RRC Idle state.
2. The NG-RAN node detects a primary source event (e.g. degradation, failure, recovery).
3. The NG-RAN generates a RAN timing synchronization status report and an associated status report ID.
4-5. The NG-RAN node broadcasts a status report ID in the cell using SIB to notify the primary source event to the UEs camping in the cell.
6. The UE reads SIB and the status report ID and:
   Alternative a), if the UE does not have stored locally the RAN timing synchronization status report corresponding to the status report ID, the UE retrieves a new RAN timing synchronization status report corresponding to the status report ID the NG-RAN Otherwise, the UE uses the locally stored RAN timing synchronization status report and steps 7-9 are skipped; or
   Alternative b), the UE uses the status report ID as an index to map to the pre-defined and/or standardized characteristics. Steps 7-9 are skipped.
   Alternative c), the UE uses the status report ID as an index to map to the codebook. Steps 7-9 are skipped.
7. In the case of alternative a), or if index was not found for alternative b) in step 10 and for alternative c) in step 11, the UE enters RRC_CONNECTED.
8. In the case of alternative a), or if index was not found for alternative b) in step 10 or for alternative c) in step 11. after UE moves to RRC_CONNECTED mode, the NG-RAN determines the UE is subscribed to RAN timing synchronization status (e.g. based on configuration provided by the TSCTSF via AMF).
9. In the case of alternative a), or if index was not found for alternative b) in step 10 or for alternative c) in step 11, the NG-RAN node sends the last available RAN timing synchronization status report with its associated status report ID to the UE via dedicated RRC signalling. The UE may store the RAN timing synchronization status report with the corresponding status report ID locally for a configured time or until deregistration, and thus avoid the need to reconnect with the network.
10. In the case of alternative b) the UE uses the report ID as an index to map to the pre-defined and/or standardized characteristics that describe the RAN timing synchronization status. If the index is not found in pre-defined/standardized list of characteristics, then the UE performs steps 7-9.
11. In the case of alternative c) the UE uses the event ID as index to map to a set of time synchronization characteristics in a codebook previously provided by RAN to UE during registration process. If the index is not found in the codebook, then the UE wil perform steps 7-9.

### ***** END OF CHANGES TO 3GPP TR 23.700-25 *****

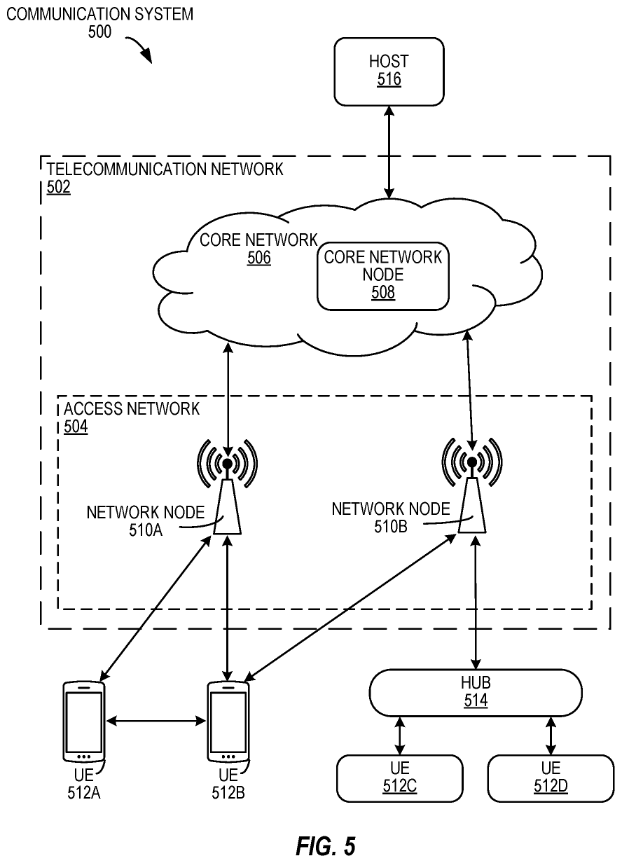

FIG. 5 shows an example of a communication system 500 in accordance with some embodiments.

In the example, the communication system 500 includes a telecommunication network 502 that includes an access network 504, such as a Radio Access Network (RAN), and a core network 506, which includes one or more core network nodes 508. The access network 504 includes one or more access network nodes, such as network nodes 510A and 510B (one or more of which may be generally referred to as network nodes 510), or any other similar Third Generation Partnership Project (3GPP) access node or non-3GPP Access Point (AP). The network nodes 510 facilitate direct or indirect connection of User Equipment (UE), such as by connecting UEs 512A, 512B, 512C, and 512D (one or more of which may be generally referred to as UEs 512) to the core network 506 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 500 may include any number of wired or wireless networks, network nodes, UEs, and/or any other components or systems that may facilitate or participate in the communication of data and/or signals whether via wired or wireless connections. The communication system 500 may include and/or interface with any type of communication, telecommunication, data, cellular, radio network, and/or other similar type of system.

The UEs 512 may be any of a wide variety of communication devices, including wireless devices arranged, configured, and/or operable to communicate wirelessly with the network nodes 510 and other communication devices. Similarly, the network nodes 510 are arranged, capable, configured, and/or operable to communicate directly or indirectly with the UEs 512 and/or with other network nodes or equipment in the telecommunication network 502 to enable and/or provide network access, such as wireless network access, and/or to perform other functions, such as administration in the telecommunication network 502.

In the depicted example, the core network 506 connects the network nodes 510 to one or more hosts, such as host 516. These connections may be direct or indirect via one or more intermediary networks or devices. In other examples, network nodes may be directly coupled to hosts. The core network 506 includes one more core network nodes (e.g., core network node 508) that are structured with hardware and software components. Features of these components may be substantially similar to those described with respect to the UEs, network nodes, and/or hosts, such that the descriptions thereof are generally applicable to the corresponding components of the core network node 508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 516 may be under the ownership or control of a service provider other than an operator or provider of the access network 504 and/or the telecommunication network 502, and may be operated by the service provider or on behalf of the service provider. The host 516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 500 of FIG. 5 enables connectivity between the UEs, network nodes, and hosts. In that sense, the communication system 500 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 502 is a cellular network that implements 3GPP standardized features. Accordingly, the telecommunication network 502 may support network slicing to provide different logical networks to different devices that are connected to the telecommunication network 502. For example, the telecommunication network 502 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 512 are configured to transmit and/or receive information without direct human interaction. For instance, a UE may be designed to transmit information to the access network 504 on a predetermined schedule, when triggered by an internal or external event, or in response to requests from the access network 504. Additionally, a UE may be configured for operating in single-or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 514 communicates with the access network 504 to facilitate indirect communication between one or more UEs (e.g., UE 512C and/or 512D) and network nodes (e.g., network node 510B). In some examples, the hub 514 may be a controller, router, content source and analytics, or any of the other communication devices described herein regarding UEs. For example, the hub 514 may be a broadband router enabling access to the core network 506 for the UEs. As another example, the hub 514 may be a controller that sends commands or instructions to one or more actuators in the UEs. Commands or instructions may be received from the UEs, network nodes 510, or by executable code, script, process, or other instructions in the hub 514. As another example, the hub 514 may be a data collector that acts as temporary storage for UE data and, in some embodiments, may perform analysis or other processing of the data. As another example, the hub 514 may be a content source. For example, for a UE that is a Virtual Reality (VR) headset, display, loudspeaker or other media delivery device, the hub 514 may retrieve VR assets, video, audio, or other media or data related to sensory information via a network node, which the hub 514 then provides to the UE either directly, after performing local processing, and/or after adding additional local content. In still another example, the hub 514 acts as a proxy server or orchestrator for the UEs, in particular in if one or more of the UEs are low energy IoT devices.

The hub 514 may have a constant/persistent or intermittent connection to the network node 510B. The hub 514 may also allow for a different communication scheme and/or schedule between the hub 514 and UEs (e.g., UE 512C and/or 512D), and between the hub 514 and the core network 506. In other examples, the hub 514 is connected to the core network 506 and/or one or more UEs via a wired connection. Moreover, the hub 514 may be configured to connect to a Machine-to-Machine (M2M) service provider over the access network 504 and/or to another UE over a direct connection. In some scenarios, UEs may establish a wireless connection with the network nodes 510 while still connected via the hub 514 via a wired or wireless connection. In some embodiments, the hub 514 may be a dedicated hub-that is, a hub whose primary function is to route communications to/from the UEs from/to the network node 510B. In other embodiments, the hub 514 may be a non-dedicated hub-that is, a device which is capable of operating to route communications between the UEs and the network node 510B, but which is additionally capable of operating as a communication start and/or end point for certain data channels.

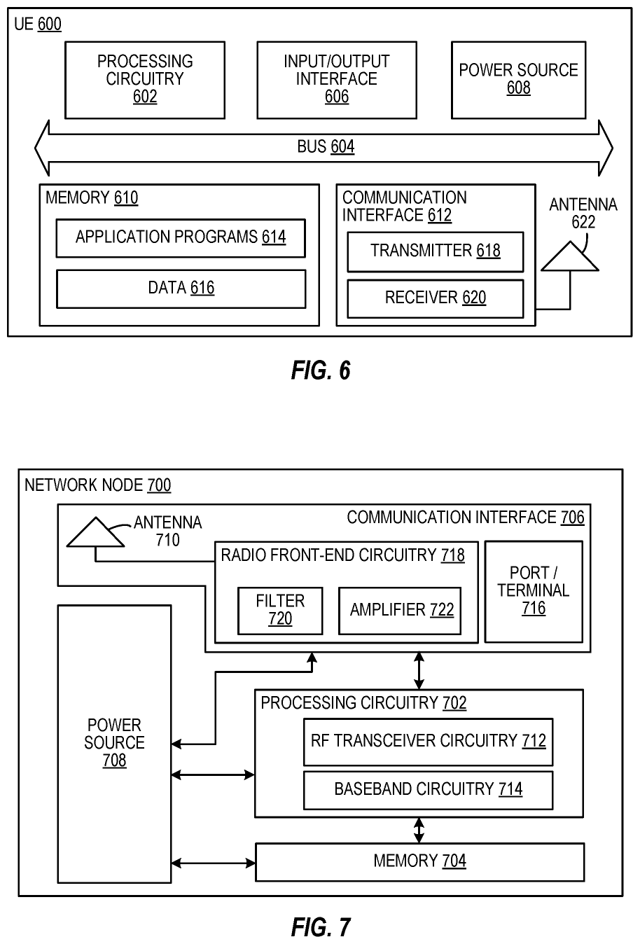

FIG. 6 shows a UE 600 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VolP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 600 includes processing circuitry 602 that is operatively coupled via a bus 604 to an input/output interface 606, a power source 608, memory 610, a communication interface 612, and/or any other component, or any combination thereof. Certain UEs may utilize all or a subset of the components shown in FIG. 6. The level of integration between the components may vary from one UE to another UE. Further, certain UEs may contain multiple instances of a component, such as multiple processors, memories, transceivers, transmitters, receivers, etc.

The processing circuitry 602 is configured to process instructions and data and may be configured to implement any sequential state machine operative to execute instructions stored as machine-readable computer programs in the memory 610. The processing circuitry 602 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 602 may include multiple Central Processing Units (CPUs).

In the example, the input/output interface 606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 608 is structured as a battery or battery pack. Other types of power sources, such as an external power source (e.g., an electricity outlet), photovoltaic device, or power cell, may be used. The power source 608 may further include power circuitry for delivering power from the power source 608 itself, and/or an external power source, to the various parts of the UE 600 via input circuitry or an interface such as an electrical power cable. Delivering power may be, for example, for charging the power source 608. Power circuitry may perform any formatting, converting, or other modification to the power from the power source 608 to make the power suitable for the respective components of the UE 600 to which power is supplied.

The memory 610 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 610 includes one or more application programs 614, such as an operating system, web browser application, a widget, gadget engine, or other application, and corresponding data 616. The memory 610 may store, for use by the UE 600, any of a variety of various operating systems or combinations of operating systems.

The memory 610 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 610 may allow the UE 600 to access instructions, application programs, and the like stored on transitory or non-transitory memory media, to off-load data, or to upload data. An article of manufacture, such as one utilizing a communication system, may be tangibly embodied as or in the memory 610, which may be or comprise a device-readable storage medium.

The processing circuitry 602 may be configured to communicate with an access network or other network using the communication interface 612. The communication interface 612 may comprise one or more communication subsystems and may include or be communicatively coupled to an antenna 622. The communication interface 612 may include one or more transceivers used to communicate, such as by communicating with one or more remote transceivers of another device capable of wireless communication (e.g., another UE or a network node in an access network). Each transceiver may include a transmitter 618 and/or a receiver 620 appropriate to provide network communications (e.g., optical, electrical, frequency allocations, and so forth). Moreover, the transmitter 618 and receiver 620 may be coupled to one or more antennas (e.g., the antenna 622) and may share circuit components, software, or firmware, or alternatively be implemented separately.

In the illustrated embodiment, communication functions of the communication interface 612 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 612, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 600 shown in FIG. 6.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 7 shows a network node 700 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 700 includes processing circuitry 702, memory 704, a communication interface 706, and a power source 708. The network node 700 may be composed of multiple physically separate components (e.g., a Node B component and an RNC component, or a BTS component and a BSC component, etc.), which may each have their own respective components. In certain scenarios in which the network node 700 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 700 may be configured to support multiple RATs. In such embodiments, some components may be duplicated (e.g., separate memory 704 for different RATs) and some components may be reused (e.g., an antenna 710 may be shared by different RATs). The network node 700 may also include multiple sets of the various illustrated components for different wireless technologies integrated into network node 700, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 700.

The processing circuitry 702 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 700 components, such as the memory 704, to provide network node 700 functionality.

In some embodiments, the processing circuitry 702 includes a System on a Chip (SOC). In some embodiments, the processing circuitry 702 includes one or more of Radio Frequency (RF) transceiver circuitry 712 and baseband processing circuitry 714. In some embodiments, the RF transceiver circuitry 712 and the baseband processing circuitry 714 may be on separate chips (or sets of chips), boards, or units, such as radio units and digital units. In alternative embodiments, part or all of the RF transceiver circuitry 712 and the baseband processing circuitry 714 may be on the same chip or set of chips, boards, or units.

The memory 704 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 702. The memory 704 may store any suitable instructions, data, or information, including a computer program, software, an application including one or more of logic, rules, code, tables, and/or other instructions capable of being executed by the processing circuitry 702 and utilized by the network node 700. The memory 704 may be used to store any calculations made by the processing circuitry 702 and/or any data received via the communication interface 706. In some embodiments, the processing circuitry 702 and the memory 704 are integrated.

The communication interface 706 is used in wired or wireless communication of signaling and/or data between a network node, access network, and/or UE. As illustrated, the communication interface 706 comprises port(s)/terminal(s) 716 to send and receive data, for example to and from a network over a wired connection. The communication interface 706 also includes radio front-end circuitry 718 that may be coupled to, or in certain embodiments a part of, the antenna 710. The radio front-end circuitry 718 comprises filters 720 and amplifiers 722. The radio front-end circuitry 718 may be connected to the antenna 710 and the processing circuitry 702. The radio front-end circuitry 718 may be configured to condition signals communicated between the antenna 710 and the processing circuitry 702. The radio front-end circuitry 718 may receive digital data that is to be sent out to other network nodes or UEs via a wireless connection. The radio front-end circuitry 718 may convert the digital data into a radio signal having the appropriate channel and bandwidth parameters using a combination of the filters 720 and/or the amplifiers 722. The radio signal may then be transmitted via the antenna 710. Similarly, when receiving data, the antenna 710 may collect radio signals which are then converted into digital data by the radio front-end circuitry 718. The digital data may be passed to the processing circuitry 702. In other embodiments, the communication interface 706 may comprise different components and/or different combinations of components.

In certain alternative embodiments, the network node 700 does not include separate radio front-end circuitry 718; instead, the processing circuitry 702 includes radio front-end circuitry and is connected to the antenna 710. Similarly, in some embodiments, all or some of the RF transceiver circuitry 712 is part of the communication interface 706. In still other embodiments, the communication interface 706 includes the one or more ports or terminals 716, the radio front-end circuitry 718, and the RF transceiver circuitry 712 as part of a radio unit (not shown), and the communication interface 706 communicates with the baseband processing circuitry 714, which is part of a digital unit (not shown).

The antenna 710 may include one or more antennas, or antenna arrays, configured to send and/or receive wireless signals. The antenna 710 may be coupled to the radio front-end circuitry 718 and may be any type of antenna capable of transmitting and receiving data and/or signals wirelessly. In certain embodiments, the antenna 710 is separate from the network node 700 and connectable to the network node 700 through an interface or port.

The antenna 710, the communication interface 706, and/or the processing circuitry 702 may be configured to perform any receiving operations and/or certain obtaining operations described herein as being performed by the network node 700. Any information, data, and/or signals may be received from a UE, another network node, and/or any other network equipment. Similarly, the antenna 710, the communication interface 706, and/or the processing circuitry 702 may be configured to perform any transmitting operations described herein as being performed by the network node 700. Any information, data, and/or signals may be transmitted to a UE, another network node, and/or any other network equipment.

The power source 708 provides power to the various components of the network node 700 in a form suitable for the respective components (e.g., at a voltage and current level needed for each respective component). The power source 708 may further comprise, or be coupled to, power management circuitry to supply the components of the network node 700 with power for performing the functionality described herein. For example, the network node 700 may be connectable to an external power source (e.g., the power grid or an electricity outlet) via input circuitry or an interface such as an electrical cable, whereby the external power source supplies power to power circuitry of the power source 708. As a further example, the power source 708 may comprise a source of power in the form of a battery or battery pack which is connected to, or integrated in, power circuitry. The battery may provide backup power should the external power source fail.

Embodiments of the network node 700 may include additional components beyond those shown in FIG. 7 for providing certain aspects of the network node's functionality, including any of the functionality described herein and/or any functionality necessary to support the subject matter described herein. For example, the network node 700 may include user interface equipment to allow input of information into the network node 700 and to allow output of information from the network node 700. This may allow a user to perform diagnostic, maintenance, repair, and other administrative functions for the network node 700.

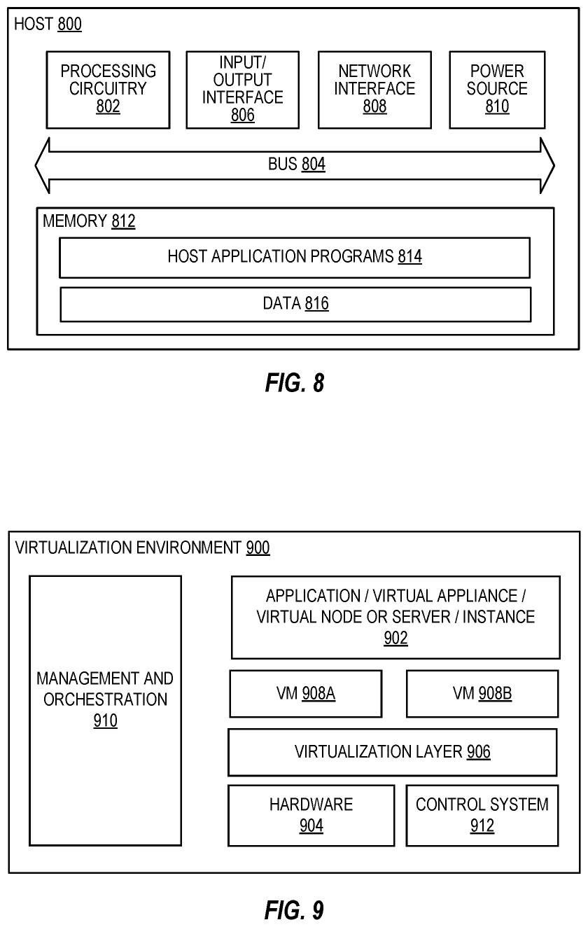

FIG. 8 is a block diagram of a host 800, which may be an embodiment of the host 516 of FIG. 5, in accordance with various aspects described herein. As used herein, the host 800 may be or comprise various combinations of hardware and/or software including a standalone server, a blade server, a cloud-implemented server, a distributed server, a virtual machine, container, or processing resources in a server farm. The host 800 may provide one or more services to one or more UEs.

The host 800 includes processing circuitry 802 that is operatively coupled via a bus 804 to an input/output interface 806, a network interface 808, a power source 810, and memory 812. Other components may be included in other embodiments. Features of these components may be substantially similar to those described with respect to the devices of previous figures, such as FIGS. 6 and 7, such that the descriptions thereof are generally applicable to the corresponding components of the host 800.

The memory 812 may include one or more computer programs including one or more host application programs 814 and data 816, which may include user data, e.g. data generated by a UE for the host 800 or data generated by the host 800 for a UE. Embodiments of the host 800 may utilize only a subset or all of the components shown. The host application programs 814 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 814 may also provide for user authentication and licensing checks and may periodically report health, routes, and content availability to a central node, such as a device in or on the edge of a core network. Accordingly, the host 800 may select and/or indicate a different host for Over-The-Top (OTT) services for a UE. The host application programs 814 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 9 is a block diagram illustrating a virtualization environment 900 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or VM Monitors (VMMs)), provide VMs 908A and 908B (one or more of which may be generally referred to as VMs 908), and/or perform any of the functions, features, and/or benefits described in relation with some embodiments described herein. The virtualization layer 906 may present a virtual operating platform that appears like networking hardware to the VMs 908.

The VMs 908 comprise virtual processing, virtual memory, virtual networking, or interface and virtual storage, and may be run by a corresponding virtualization layer 906. Different embodiments of the instance of a virtual appliance 902 may be implemented on one or more of the VMs 908, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 908 may be a software implementation of a physical machine that runs programs as if they were executing on a physical, non-virtualized machine. Each of the VMs 908, and that part of the hardware 904 that executes that VM, be it hardware dedicated to that VM and/or hardware shared by that VM with others of the VMs 908, forms separate virtual network elements. Still in the context of NFV, a virtual network function is responsible for handling specific network functions that run in one or more VMs 908 on top of the hardware 904 and corresponds to the application 902.

The hardware 904 may be implemented in a standalone network node with generic or specific components. The hardware 904 may implement some functions via virtualization. Alternatively, the hardware 904 may be part of a larger cluster of hardware (e.g., such as in a data center or CPE) where many hardware nodes work together and are managed via management and orchestration 910, which, among others, oversees lifecycle management of the applications 902. In some embodiments, the hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 912 which may alternatively be used for communication between hardware nodes and radio units.

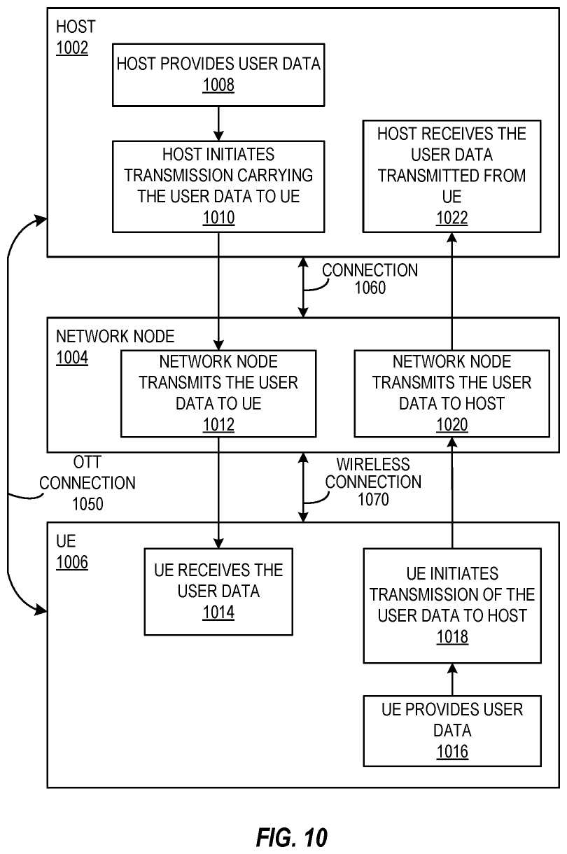

FIG. 10 shows a communication diagram of a host 1002 communicating via a network node 1004 with a UE 1006 over a partially wireless connection in accordance with some embodiments. Example implementations, in accordance with various embodiments, of the UE (such as the UE 512A of FIG. 5 and/or the UE 600 of FIG. 6), the network node (such as the network node 510A of FIG. 5 and/or the network node 700 of FIG. 7), and the host (such as the host 516 of FIG. 5 and/or the host 800 of FIG. 8) discussed in the preceding paragraphs will now be described with reference to FIG. 10.

Like the host 800, embodiments of the host 1002 include hardware, such as a communication interface, processing circuitry, and memory. The host 1002 also includes software, which is stored in or is accessible by the host 1002 and executable by the processing circuitry. The software includes a host application that may be operable to provide a service to a remote user, such as the UE 1006 connecting via an OTT connection 1050 extending between the UE 1006 and the host 1002. In providing the service to the remote user, a host application may provide user data which is transmitted using the OTT connection 1050.

The network node 1004 includes hardware enabling it to communicate with the host 1002 and the UE 1006 via a connection 1060. The connection 1060 may be direct or pass through a core network (like the core network 506 of FIG. 5) and/or one or more other intermediate networks, such as one or more public, private, or hosted networks. For example, an intermediate network may be a backbone network or the Internet.

The UE 1006 includes hardware and software, which is stored in or accessible by the UE 1006 and executable by the UE's processing circuitry. The software includes a client application, such as a web browser or operator-specific “app” that may be operable to provide a service to a human or non-human user via the UE 1006 with the support of the host 1002. In the host 1002, an executing host application may communicate with the executing client application via the OTT connection 1050 terminating at the UE 1006 and the host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via the connection 1060 between the host 1002 and the network node 1004 and via a wireless connection 1070 between the network node 1004 and the UE 1006 to provide the connection between the host 1002 and the UE 1006. The connection 1060 and the wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004 in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve, e.g., data rate and/or latency and thereby provide benefits such as, e.g., reduced user waiting time, relaxed restriction on file size, improved content resolution, and/or better responsiveness.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR, or AR which it can broadcast, multicast, or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1050 between the host 1002 and the UE 1006 in response to variations in the measurement results. The measurement procedure and/or the network functionality for reconfiguring the OTT connection 1050 may be implemented in software and hardware of the host 1002 and/or the UE 1006. In some embodiments, sensors (not shown) may be deployed in or in association with other devices through which the OTT connection 1050 passes; the sensors may participate in the measurement procedure by supplying values of the monitored quantities exemplified above, or by supplying values of other physical quantities from which software may compute or estimate the monitored quantities. The reconfiguring of the OTT connection 1050 may include message format, retransmission settings, preferred routing, etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency, and the like by the host 1002. The measurements may be implemented in that software causes messages to be transmitted, in particular empty or ‘dummy’ messages, using the OTT connection 1050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some exemplary embodiments of the present disclosure are as follows:

Embodiment 1: A method performed by a User Equipment, UE, (104), the method comprising: receiving (110A or 110B), from a network node (100 or 102), one or more time status information instance codebooks each comprising a set of possible time status information instances associated to respective time status information instance identifiers; and storing (112) the one or more time status information instance codebooks.

Embodiment 2: The method of embodiment 1 further comprising receiving (118) a time status information instance identifier from a Radio Access Network, RAN, node (102).

Embodiment 3: The method of embodiment 2 wherein the one or more time status information instance codebooks consists of a single time status information instance codebook, and the method further comprises determining (120) that a time status information instance in the single time status information instance codebook that is associated to the received time status information instance identifier is time status information applicable to the UE (104).

Embodiment 4: The method of embodiment 2 wherein the one or more time status information instance codebooks comprise two or more time status information instance codebooks, and the method further comprises: selecting (116) a particular time status information instance codebook from the two or more time status information instance codebooks; and determining (120) that a time status information instance in the particular time status information instance codebook that is associated to the received time status information instance identifier is time status information applicable to the UE (104).

Embodiment 5: The method of embodiment 4 further comprising: receiving (114) an indication of a particular time status information instance codebook from the two or more time status information instance codebooks to be used by the UE (102); wherein selecting (116) the particular time status information instance codebook comprises selecting (116) the particular time status information instance codebook from the two or more time status information instance codebooks based on the received indication.

Embodiment 6: The method of embodiment 4 wherein selecting (116) the particular time status information instance codebook comprises selecting (116) the particular time status information instance codebook from the two or more time status information instance codebooks based on one or more criteria.

Embodiment 7: The method of any of embodiments 3 to 6 further comprising performing (122) one or more actions based on the time status information applicable to the UE (104) as determined based on the received time status information instance identifier.

Embodiment 8: The method of embodiment 2 further comprising: determining (400) that the received time status information instance identifier does not correspond to any time status information instance in the one or more time status information instance codebooks; and, responsive thereto, transitioning (402) to a connected state and receiving (402) a time status report from a network node while in the connected state.

Embodiment 9: The method of any of embodiments 1 to 8 wherein the network node (100; 102) is a network node in a cellular communications system, and each time status information instance in each of the one or more time status information instance codebooks comprises information about a time synchronization status of the cellular communications system.

Embodiment 10: The method of any of embodiments 1 to 9 further comprising: determining (200) that a new time status information instance codebook is needed; and, responsive to determining (200) that a new time status information instance codebook is needed, obtaining (202) one or more new time status information instance codebooks from a network node.

Embodiment 11: The method of any of embodiments 1 to 9 further comprising receiving one or more new status information instance codebooks from a network node.

Embodiment 12: The method of any of embodiments 1 to 11 wherein the network node (100) is a core network node (100).

Embodiment 13: The method of any of embodiments 1 to 11 wherein the network node (102) is a Radio Access Network, RAN, node (102).

Embodiment 14: A User Equipment, UE, (104) adapted to perform the method of any of embodiments 1 to 13.

Embodiment 15: A method performed by a network node (100; 102), the method comprising: providing (110A or 110B), to a User Equipment, UE, (104), one or more time status information instance codebooks each comprising a set of possible time status information instances associated to respective time status information instance identifiers.

Embodiment 16: The method of embodiment 15 wherein the network node (102) is a Radio Access Network, RAN, node (102).

Embodiment 17: The method of embodiment 16 further comprising transmitting (118) a time status information instance identifier to the UE (104), the time status information instance identifier being associated to a time status information instance in one of the one or more time status information instance codebooks.

Embodiment 18: The method of embodiment 17 wherein the one or more time status information instance codebooks consists of a single time status information instance codebook, and the time status information instance identifier is associated to a time status information instance in the single time status information instance codebook.

Embodiment 19: The method of embodiment 17 wherein the one or more time status information instance codebooks comprise two or more time status information instance codebooks, and the method further comprises: transmitting (114), to the UE (104), an indication of a particular time status information instance codebook from the two or more time status information instance codebooks to be used by the UE (102); wherein the time status information instance identifier is associated to a time status information instance in the particular time status information instance codebook.

Embodiment 20: The method of any of embodiments 16 to 19 further comprising receiving (108), from another network node (100), either the one or more time status information instance codebooks or one or more respective identifiers of the one or more time status information instance codebooks.

Embodiment 21: The method of embodiment 15 wherein the network node (102) is a core network node (100).

Embodiment 22: The method of embodiment 21 further comprising providing (108), to a RAN node (102), either the one or more time status information instance codebooks or one or more respective identifiers of the one or more time status information instance codebooks.

Embodiment 23: The method of embodiment 21 or 22 further comprising dynamically generating (106) the one or more time status information instance codebooks.

Embodiment 24: The method of any of embodiments 15 to 23 wherein the network node (100; 102) is a network node in a cellular communications system, and each time status information instance in each of the one or more time status information instance codebooks comprises information about time synchronization status of the cellular communications system.

Embodiment 25: The method of any of embodiments 15 to 24 further comprising: determining (300) that the UE (104) is in need of a new time status information instance codebook; and, responsive to determining (300) that the UE (104) is in need of a new time status information instance codebook, providing (302) one or more new time status information instance codebooks to the UE (104).

Embodiment 26: A network node (100; 102) adapted to perform the method of any of embodiments 15 to 25.

Those skilled in the art will recognize improvements and modifications to the embodiments of the present disclosure. All such improvements and modifications are considered within the scope of the concepts disclosed herein.

1. A method performed by a User Equipment (UE), the method comprising:
receiving, from a network node of a wireless network, one or more time status information instance codebooks each comprising a set of possible time status information instances associated to respective time status information instance identifiers;
storing the one or more time status information instance codebooks;
receiving a time status information instance identifier from a Radio Access Network (RAN) node;
determining the time status information instance in the codebook that is indicated by the received identifier; and
performing one or more actions based on the time status information applicable to the UE as determined based on the received time status information instance identifier.

2. (canceled)

3. The method of claim 1, wherein the one or more time status information instance codebooks consists of a single time status information instance codebook, and the method further comprises determining that a time status information instance in the single time status information instance codebook that is associated to the received time status information instance identifier is time status information applicable to the UE.

4. The method of claim 1, wherein the one or more time status information instance codebooks comprise two or more time status information instance codebooks, and the method further comprises:
selecting a particular time status information instance codebook from the two or more time status information instance codebooks; and
determining that a time status information instance in the particular time status information instance codebook that is associated to the received time status information instance identifier is time status information applicable to the UE.

5. The method of claim 4, further comprising:
receiving an indication of a particular time status information instance codebook from the two or more time status information instance codebooks to be used by the UE;
wherein selecting the particular time status information instance codebook comprises selecting the particular time status information instance codebook from the two or more time status information instance codebooks based on the received indication.

6. The method of claim 4, wherein selecting the particular time status information instance codebook comprises selecting the particular time status information instance codebook from the two or more time status information instance codebooks based on one or more criteria.

7. (canceled)

8. The method of claim 1, further comprising:
determining that the received time status information instance identifier does not correspond to any time status information instance in the one or more time status information instance codebooks; and
responsive thereto, transitioning to a connected state and receiving a time status report from a network node while in the connected state.

9. The method of claim 1, wherein the network node is a network node in a cellular communications system, and each time status information instance in each of the one or more time status information instance codebooks comprises information about a time synchronization status of the cellular communications system.

10. The method of claim 1, wherein each time status information instance in the set of possible time status information instances comprises any one or more of the following:
information about a divergence of a timing of the wireless network from Coordinated Universal Time (UTC); and
information about a degradation of a timing source of the wireless network.

11. The method of claim 1, wherein:
at least one time status information instance in the set of possible time status information instances comprises one or more clock quality metrics that reflect a current timing synchronization status of the wireless network; and
the one or more clock quality metrics comprise any one or more of the following:
timing synchronization state;
timing synchronization source type;
clock quality descriptor;
clock accuracy;
traceability to Coordinated Universal Time (UTC);
frequency stability.

12. (canceled)

13. The method of claim 1, wherein at least one time status information instance in the set of possible time status information instances comprises either an acceptable indication or a not acceptable indication.

14. The method of claim 1, further comprising:
determining that a new time status information instance codebook is needed; and
responsive to determining that a new time status information instance codebook is needed, obtaining one or more new time status information instance codebooks from a network node.

15. (canceled)

16. (canceled)

17. (canceled)

18. A User Equipment (UE) comprising:
a communication interface comprising a transmitter and a receiver; and
processing circuitry associated with the communication interface;
the UE being adapted to perform the method of claim 1.

19-23. (canceled)

24. A method performed by a network node, the method comprising:
providing, to a User Equipment (UE), one or more time status information instance codebooks each comprising a set of possible time status information instances associated to respective time status information instance identifiers.

25. The method of claim 24, wherein the network node is a Radio Access Network (RAN) node.

26. The method of claim 25, further comprising transmitting a time status information instance identifier to the UE, the time status information instance identifier being associated to a time status information instance in one of the one or more time status information instance codebooks.

27. The method of claim 26, wherein:
the one or more time status information instance codebooks consists of a single time status information instance codebook, and the time status information instance identifier is associated to a time status information instance in the single time status information instance codebook; or
the one or more time status information instance codebooks comprise two or more time status information instance codebooks, and the method further comprises:
transmitting, to the UE, an indication of a particular time status information instance codebook from the two or more time status information instance codebooks to be used by the UE;
wherein the time status information instance identifier is associated to a time status information instance in the particular time status information instance codebook.

28-45. (canceled)
